(19) United States
(12) Patent Application Publication
(10) Pub. No.: US 2021/0221018 A1
(43) Pub. Date: Jul. 22, 2021

(54) CUTTING TOOL AND A HOLE PUNCH WITH THE SAME

(71) Applicant: PAO SHEN ENTERPRISES CO., LTD., Chang Hua (TW)

(72) Inventor: Su-Yu HSU, Chang Hua (TW)

(73) Assignee: PAO SHEN ENTERPRISES CO., LTD., Chang Hua (TW)

(21) Appl. No.: 16/867,419

(22) Filed: May 5, 2020

(30) Foreign Application Priority Data
Jan. 17, 2020 (TW) 109101797

(51) Int. Cl. B26F 1/14

(52) U.S. Cl. CPC B26F 1/14; B26F 2210/02

(57) ABSTRACT

A cutting tool of a hole punch has an outer circumferential wall extending in an up-down direction and surrounding an axis, and a cutting surrounding surface extending and inclined inwardly and upwardly from a bottom peripheral edge of the outer circumferential wall toward the axis. The cutting surrounding surface has upper and lower cutting surrounding edges, and defines front and rear cutting edges. The front cutting edge has first and second lower points on the lower and upper cutting surrounding edges. The rear cutting edge has first and second upper points on the lower and upper cutting surrounding edges and higher than the first and second lower points. A concaved paper pressing curve surface extends upwardly from the upper cutting surrounding edge to define a paper moving recess.

### CROSS-REFERENCE TO RELATED APPLICATION

This application claims priority of Taiwanese Patent Application No. 109101797, filed on Jan. 17, 2020.

### FIELD

The disclosure relates to a hole punch, and more particularly to a cutting tool and a hole punch with the same.

### BACKGROUND

Referring to FIGS. 1 and 2, a conventional cutting tool of a hole punch is in the form of a cylindrical pin. The pin includes an outer circumferential wall 1 and a concaved surface 2 connected with a lower periphery of the outer circumferential wall 1. The concaved surface 2 has two inclined flat surface sections 201 and an upper curved surface section 202 connected between the flat surface sections 201 to define a V-shaped notch 3 in the concaved surface 2. A cutting edge 4 is formed at the juncture of the outer circumferential wall 1 and the concaved surface 2. The cutting edge 4 has two lower cutting points 401 opposite to each other in a left-right direction, and two higher cutting points 402 opposite to each other in a front-rear direction. When a handle of the hole punch is depressed to move the cutting tool downwardly, the two lower cutting points 401 are simultaneously pressed onto an uppermost one of a paper stack 6, and then the two higher cutting points 402 are pressed onto the paper. Hence, the cutting edge 4 is provided with the four cutting points 401, 402 to cut one paper during the punching operation of the hole punch, which results in a large contact area of the paper with the cutting tool and hence requires more effort by the user.

Moreover, when the cutting tool is pressed downwardly through the paper stack 6, a stack of paper chips 601 cut from paper sheets are deformed and forced into the V-shaped notch 3 to generate a great friction with the concaved surface 2 so as to increase resistance against the press of the cutting tool. Furthermore, the paper chips 601 are attached to the concaved surface 2 and kept in the V-shaped notch 3 until an upward movement of the cutting tool is made so that the paper chips 601 can be removed and fall from the V-shaped notch 3 by a hole edge of the hole punch that contacts with the paper chips 601, which results in inconvenience during the punching operation.

### SUMMARY

Therefore, an object of the disclosure is to provide a cutting tool and a hole punch that can alleviate at least one of the drawbacks of the prior art.

According to the disclosure, the cutting tool of a hole punch includes a cylindrical pin which has an outer circumferential wall extending in an up-down direction and surrounding an axis. A cutting surrounding surface extends and is inclined inwardly and upwardly from a bottom peripheral edge of the outer circumferential wall toward the axis. The cutting surrounding surface surrounds the axis and is surrounded by the outer circumferential wall. The cutting surrounding surface has a lower cutting surrounding edge and an upper cutting surrounding edge disposed higher than the lower cutting surrounding edge in the up-down direction. The cutting surrounding surface intersects with a vertical reference plane that is parallel to both the up-down direction and a front-rear direction to define a front cutting edge and a rear cutting edge. The front cutting edge has a first lower point on the lower cutting surrounding edge, and a second lower point on the upper cutting surrounding edge. The rear cutting edge has a first upper point on the lower cutting surrounding edge and higher than the first lower point in the up-down direction, and a second upper point on the upper cutting surrounding edge and higher than the second lower point in the up-down direction. A concaved paper pressing curve surface extends upwardly from the upper cutting surrounding edge to define a paper moving recess.

According to the disclosure, the hole punch includes an anvil seat having an anvil cavity, a frame disposed on the anvil seat, a handle module pivotably connected to said frame, and at least one cutting tool as described above. The cutting tool is disposed on and movable relative to the frame in the up-down direction and is aligned with the anvil cavity such that rotation of the handle module is translated to a vertical movement of the cutting tool through the anvil cavity.

### BRIEF DESCRIPTION OF THE DRAWINGS

Other features and advantages of the disclosure will become apparent in the following detailed description of the embodiment with reference to the accompanying drawings, of which:

FIG. 1 is a fragmentary perspective view of a conventional cutting tool of a hole punch;

FIG. 2 is a schematic view illustrating a punching operation of the conventional cutting tool for a paper stack;

FIG. 3 is a perspective view illustrating an embodiment of a hole punch according to the disclosure;

FIG. 4 is a fragmentary sectional view of the embodiment;

FIG. 5 is a perspective view of an embodiment of a cutting tool according to the disclosure;

FIG. 6 is a rear view of the cutting tool;

FIG. 7 is a fragmentary sectional view of the cutting tool; and

FIGS. 8 to 13 are fragmentary sectional views illustrating a punching stroke of the hole punch according to the embodiment.

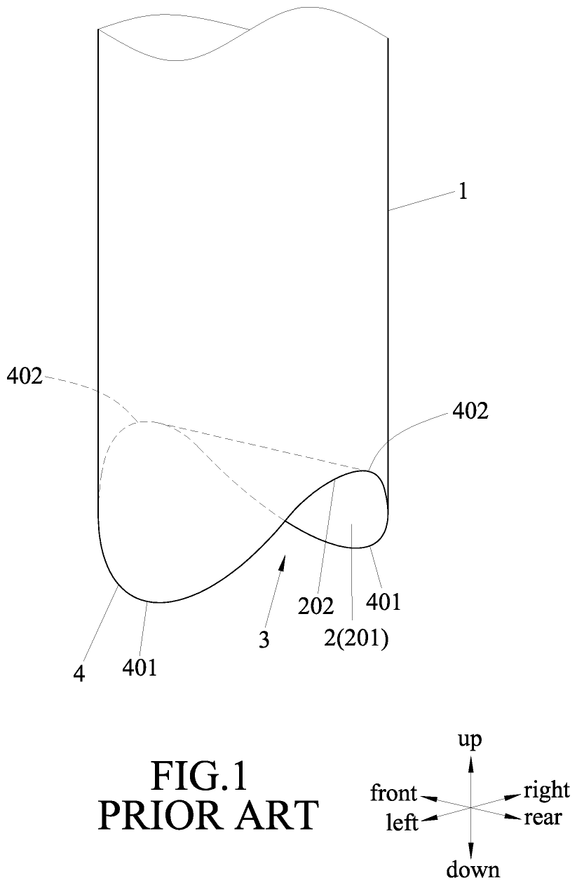

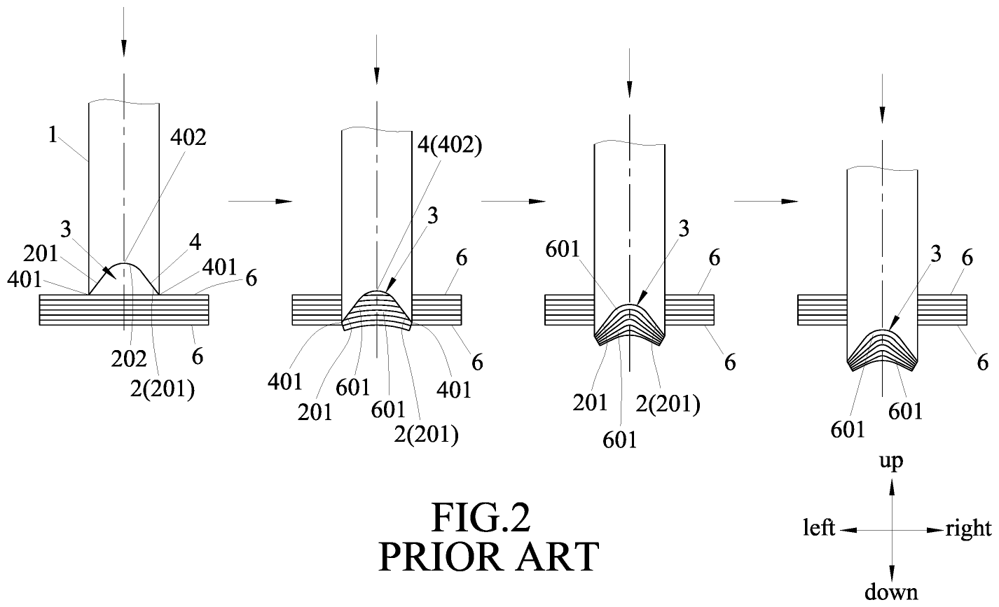

### DETAILED DESCRIPTION

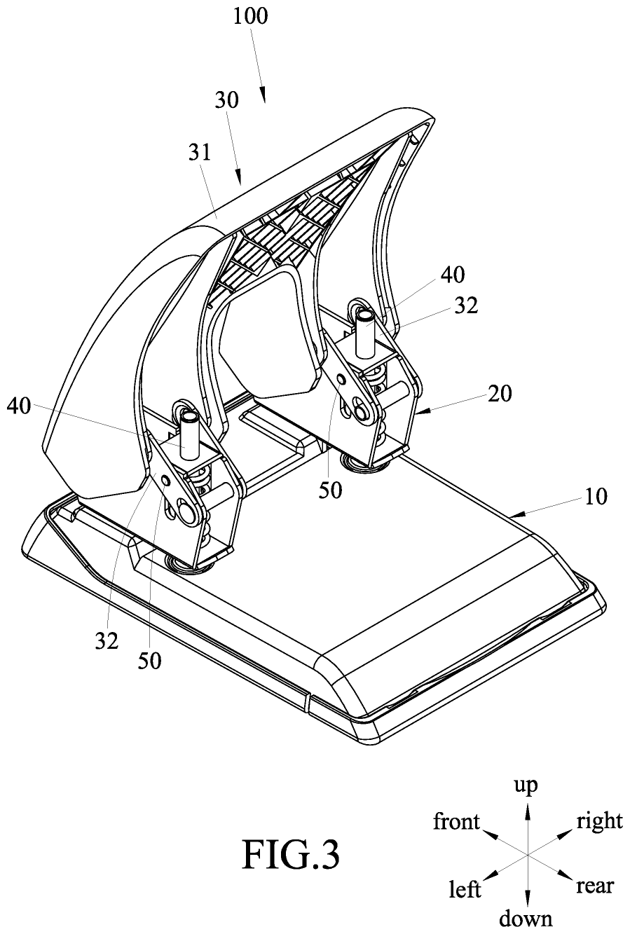

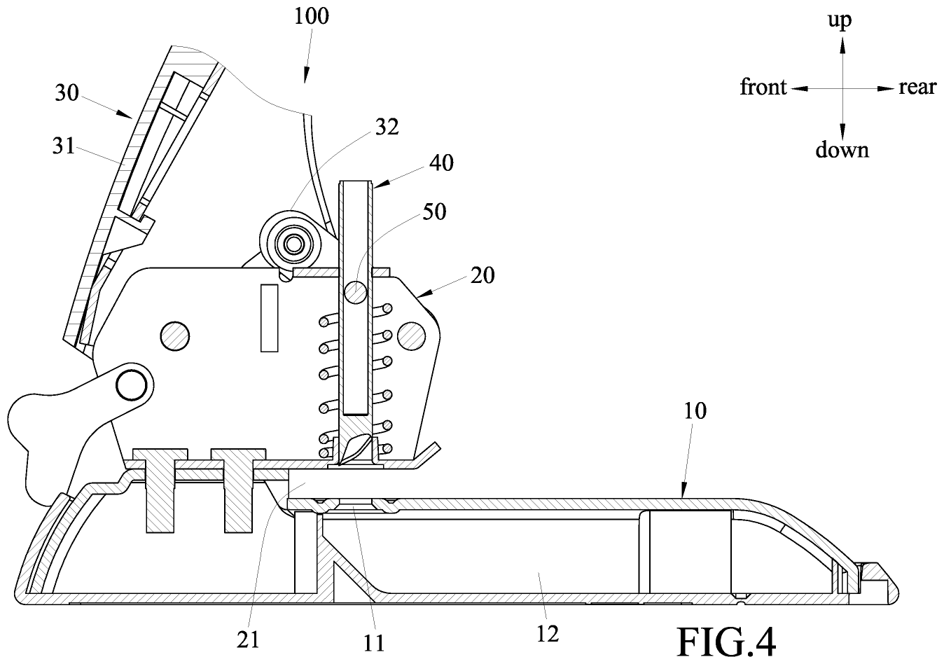

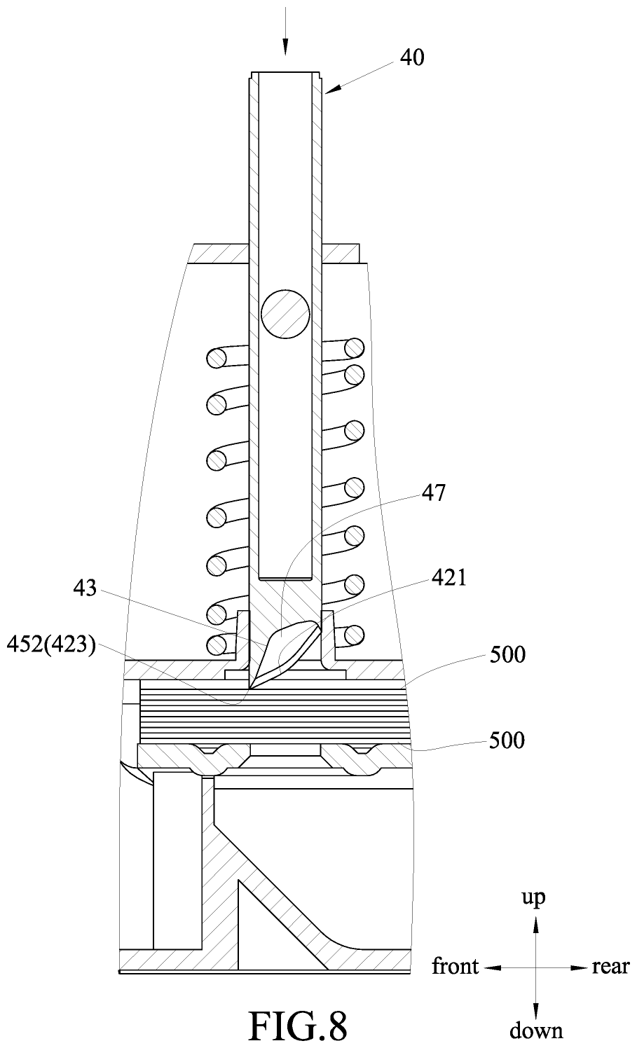

Referring to FIGS. 3 to 5, an embodiment of a hole punch 100 according to the disclosure includes an anvil seat 10, a frame 20, a handle module 30, two cutting tools 40 and two connecting pins 50. It is appreciable that in other embodiments, only one cutting tool 40 and one connecting pin 50 can be provided. The anvil seat 10 has two anvil cavities 11 spaced apart from each other in a left-right direction (only one anvil cavity 11 is shown in FIG. 4), and defines a shaving collecting space 12 below the anvil cavities 11. The frame 20 projects upwardly from a front of the anvil seat 10 and is located above and spaced apart from the anvil cavities 11 by a paper slot 21 for receiving paper sheets 500 (see FIG. 8). The handle module 30 is pivotably connected to the frame 20. In this embodiment, the handle module 30 includes a handle 31 and two linkage assemblies 32 each connected between the handle 31 and the frame 20. Each cutting tool 40 is disposed on and movable relative to the frame 20 in an up-down direction into the respective anvil cavity 11. Each connecting pin 50 is connected between the respective linkage assembly 32 and the cutting tool 40 to translate a rotation of the handle module 30 into a vertical movement of the cutting tool 40.

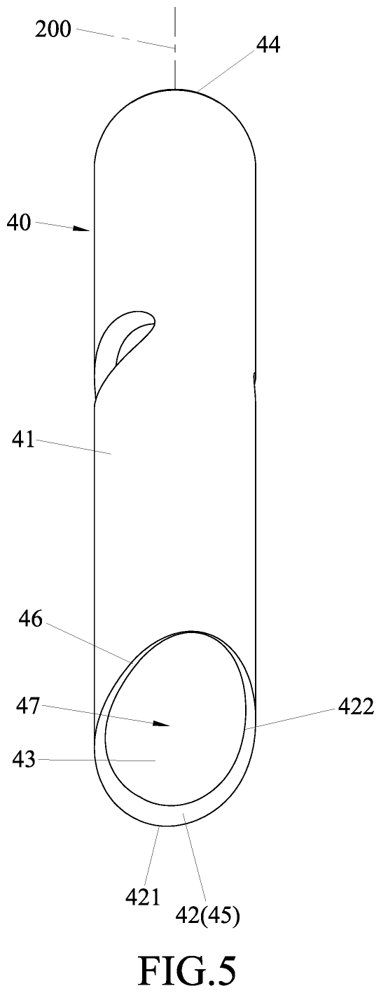

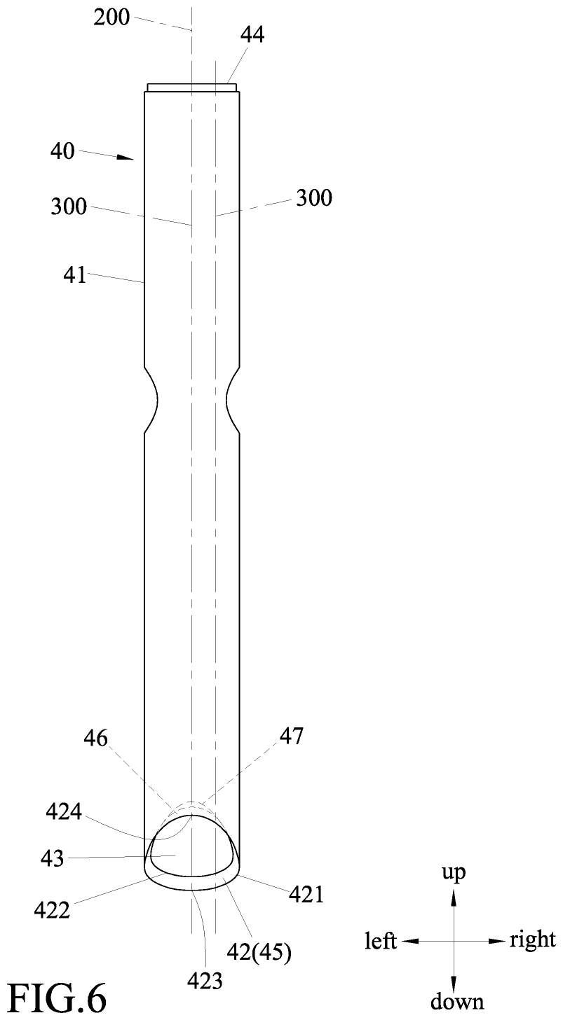

Referring to FIGS. 5 to 7, each cutting tool 40 is in the form of a cylindrical pin 40 which includes an outer circumferential wall 41, a cutting surrounding surface 42, a concaved paper pressing curve surface 43 and a top end surface 44.

The outer circumferential wall 41 extends in the up-down direction and surrounds an axis 200. The outer circumferential wall 41 intersects with one vertical reference plane 300 that is parallel to both the up-down direction and a front-rear direction to define a front side edge 411 and a rear side edge 412. The front-rear direction is perpendicular to both the left-right direction and the up-down direction.

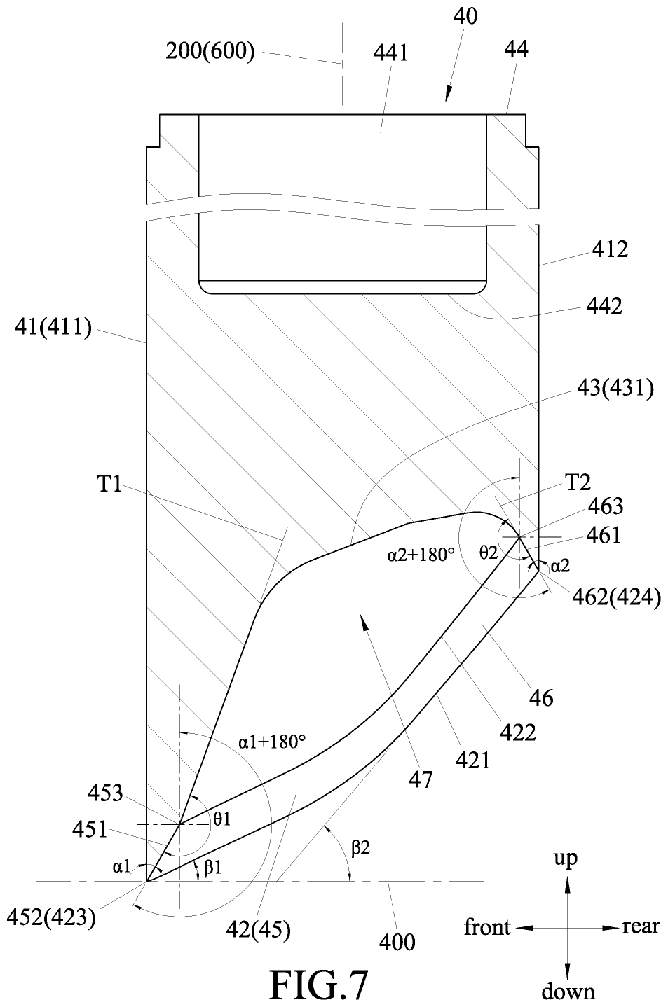

The cutting surrounding surface 42 extends and is inclined inwardly and upwardly from a bottom peripheral edge of the outer circumferential wall 41 toward the axis 200. The cutting surrounding surface 42 surrounds the axis 200 and is surrounded by the outer circumferential wall 41. Specifically, the cutting surrounding surface 42 has a lower cutting surrounding edge 421 and an upper cutting surrounding edge 422 disposed higher than the lower cutting surrounding edge 421 in the up-down direction. In this embodiment, the cutting surrounding surface 42 includes a first surrounding surface section 45 extending circumferentially to have two ends that are substantially located at a vertical reference plane 600 (see FIG. 7) containing the axis 200 and parallel to the left-right direction, and a second surrounding surface section 46 extending circumferentially and rearwardly from the ends of the first surrounding surface section 45. The first surrounding surface section 45 intersects a horizontal reference plane 400 that is normal to the axis 200 to form a first cut-in angle (β1). The second surrounding surface section 46 intersects the horizontal reference plane 400 to form a second cut-in angle (β2) that is larger than the first cut-in angle (β1). For example, in this embodiment, the first cut-in angle (β1) is 25.4 degrees, and the second cut-in angle (β2) is 49.5 degrees.

The first surrounding surface section 45 intersects with one vertical reference plane 300 to define a front cutting edge 451 that is adjoined with the front side edge 411. The second surrounding surface section 46 intersects with one vertical reference plane 300 to define a rear cutting edge 461 that is adjoined with the rear side edge 412. The front cutting edge 451 has a first lower point 452 on the lower cutting surrounding edge 421, and a second lower point 453 on the upper cutting surrounding edge 422. The rear cutting edge 461 has a first upper point 462 on the lower cutting surrounding edge 421 and higher than the first lower point 452 in the up-down direction, and a second upper point 463 on the upper cutting surrounding edge 422 and higher than the second lower point 453 in the up-down direction.

The front cutting edge 451 is connected with and intersects the front side edge 411 to form a front cutting angle (α1). The rear cutting edge 461 is connected with and intersects the rear side edge 412 to form a rear cutting angle (α2). In this embodiment, the ranges of the front and rear cutting angles are as follows: 25 degrees≤the front cutting angle (α1) 35 degrees; and 25 degrees≤the rear cutting angle (α2) 35 degrees. For example, the front cutting angle (α1) may be 30 degrees, and the rear cutting angle (α2) may be also 30 degrees.

The concaved paper pressing curve surface 43 extends upwardly from the upper cutting surrounding edge 422 to define a paper moving recess 47.

In this embodiment, the concaved paper pressing curve surface 43 does not have through holes formed therein, and intersects with one vertical reference plane 300 to define a curve edge 431 which is connected between the second lower point 453 and the second upper point 463. A front tangential line (T1) of the curve edge 431 at the second lower point 453 intersects the front cutting edge 451 to form a front paper moving angle (θ1). A rear tangential line (T2) of the curve edge 431 at the second upper point 463 intersects the rear cutting edge 461 to form a rear paper moving angle (θ2). The following conditions are satisfied: the front cutting angle (α1) +135 degrees≤the front paper moving angle (θ1)≤the front cutting angle (α1) +170 degrees; and the rear cutting angle (α2) +135 degrees the rear paper moving angle (θ2) ≤the rear cutting angle (α2) +170 degrees. For example, in this embodiment, the front paper moving angle (θ1) may be 190 degrees, and the rear paper moving angle (θ2) may be 179 degrees. With this way, the extending direction of the front tangential line (T1) is neither parallel nor perpendicular to the extending direction of the rear tangential line (T2) (see FIG. 7).

The top end surface 44 is connected with a top periphery of the outer circumferential wall 41. The top end surface 44 is formed with a weight reducing hole 441 which extends downwardly toward the concaved paper pressing curve surface 43 and terminates at a hole bottom 442 that is spaced apart from the concaved paper pressing curve surface 43.

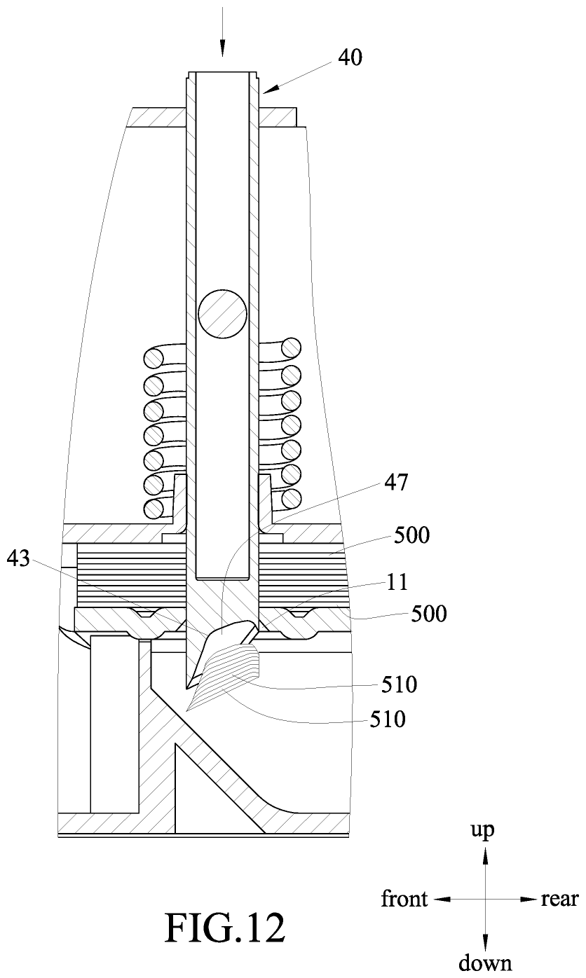

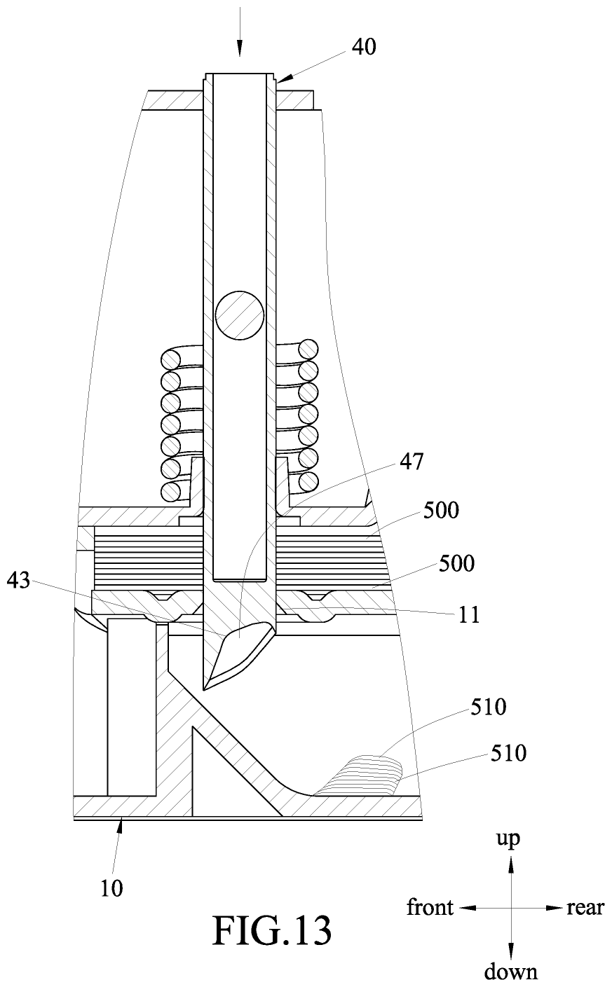

FIGS. 8 to 13 illustrate a punching stroke of the hole punch according to the embodiment for a paper stack 500, wherein only one cutting tool 40 is shown.

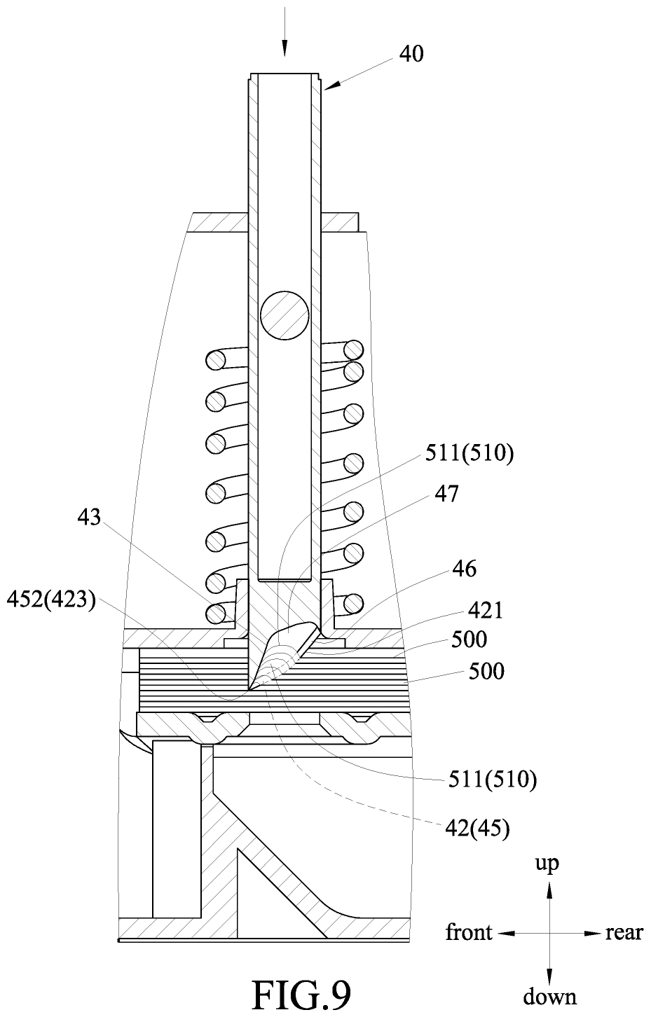

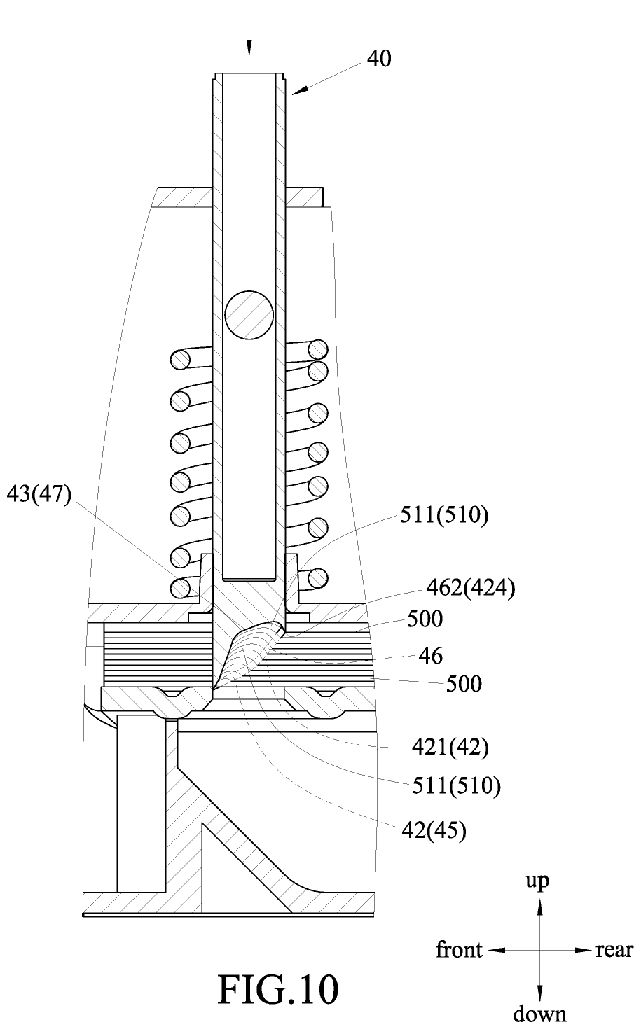

Referring to FIGS. 8 and 9, when the cutting tool 40 performs a downward punching stroke in response to the rotation of the handle module 30 (see FIG. 4) , a lowest cutting tip 423 of the lower cutting surrounding edge 421 at the first lower point 452 first contacts the uppermost paper sheet 500 (one point contact), and, as shown in FIG. 10, a highest cutting tip 424 of the lower cutting surrounding edge 421 at the first upper point 462 finally contacts the paper sheet 500 (one point contact). During this stroke, that is between the lowest cutting tip 423 and the highest cutting tip 424, the lower cutting surrounding edge 421 contacts the paper sheet 500 with two points totally. Namely, during the punching stroke, the lower cutting surrounding edge 421 of the cutting tool 40 contacts any one of the paper sheets 500 with at most two points, which reduces the contact area of the lower cutting surrounding edge 421 with the respective paper sheet 500 and hence enjoys reduced cutting forces required to press by a user.

Further, as shown in FIGS. 8 to 11, during the punching stroke, paper chips 511 of the paper stack 500 cut from the paper sheets 500 are smoothly pressed into the paper moving recess 47, and are deformed and curved in compliance with the curvature of the concaved paper pressing curve surface 43. With the concaved paper pressing curve surface 43, a relatively small degree of deformation and bending of the paper chips 511 occur. Meanwhile, paper chips 510 partly cut from the paper stack 500 can contact the concaved paper pressing curve surface 43 only at front sides thereof. Thus, a frictional resistance of the paper sheets 500 against the movement of the cutting tool 40 is reduced.

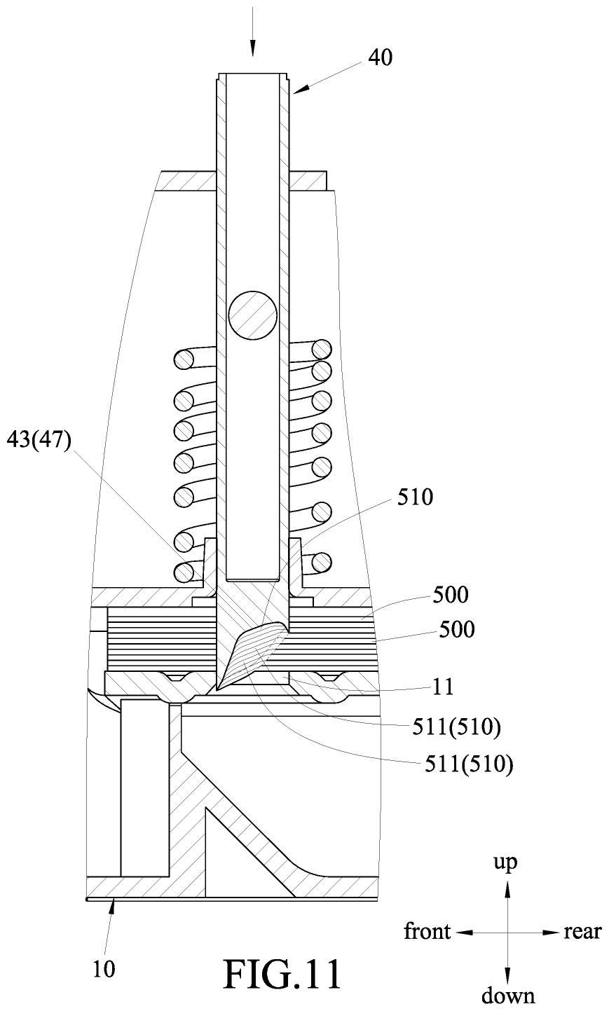

Furthermore, as shown in FIGS. 11 to 13, when the cutting tool 40 moves down through all the paper stack 500, since the paper chips 510 are caused to have a small degree of bending deformation in the paper moving recess 47, the paper chips 510 can be removed from the concaved paper pressing curve surface 43 and fall due to their own gravity.

Additionally, as shown in FIGS. 7, 9 and 10, with the second cut-in angle (β2) that is larger than the first cut-in angle (β1), during the process of cutting any paper sheet 500 by the lower cutting edge 421 of the cutting surrounding surface 42, the length of the paper sheet 500 cut at the second surrounding surface section 46 is smaller than that cut at the first surrounding surface section 45, such that less effort is required when cutting at the second surrounding surface section 46.

As illustrated, with the inclined design of the lower cutting edge 421 of the cutting tool 40 in the front-rear direction, during the punching stroke, the lower cutting surrounding edge 421 contacts any paper sheet 500 with at most two points, which reduces the contact area of the lower cutting surrounding edge 421 with the paper sheet 500 and hence enjoys reduced cutting forces required to press by a user. Also, with the concaved paper pressing curve surface 43, during the punching stroke, paper chips 511 of the paper stack 500 are smoothly pressed into the paper moving recess 47, and are deformed and bent with a relatively small degree. The paper chips 510 partly cut can contact the concaved paper pressing curve surface 43 to a less extent, such that a frictional resistance of the paper sheets 500 against the movement of the cutting tool 40 can be reduced to thereby achieve the advantage of effort saving. Besides, the paper chips 510 can be removed from the concaved paper pressing curve surface 43 and fall due to their own gravity. Moreover, with the different slopes of the first and second surrounding surface sections 45, 46, during the cutting stroke, operation of the pressing by the user is smooth and effortless to avoid occurrence of undesired hesitation.

In this embodiment, due to the satisfaction of the conditions “the front cutting angle (α1) +135 degrees≤the front paper moving angle (θ1)≤the front cutting angle (α1) +170 degrees”, and “the rear cutting angle (α2) +135 degrees≤the rear paper moving angle (θ2)≤the rear cutting angle (α2) +170 degrees”, the extending directions of the front and second tangential lines (T1, T2) are neither parallel nor perpendicular to each other. That is, the front paper moving angle (α1) is less than the front cutting angle (α1) +180 degrees, and the rear paper moving angle (θ2) is less than the rear cutting angle (α2) +180 degrees. Thus, front and rear ends of the paper chips 510 cut from the paper sheets 500 are prevented from attachment to the concaved paper pressing curve surface 43 when they are pressed in the paper moving recess 47 so as to prevent from sticking of the paper chips 510 in the paper moving recess 47.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A cutting tool of a hole punch, comprising:
a cylindrical pin including
an outer circumferential wall extending in an up-down direction and surrounding an axis;
a cutting surrounding surface extending and inclined inwardly and upwardly from a bottom peripheral edge of said outer circumferential wall toward the axis, said cutting surrounding surface surrounding the axis and being surrounded by said outer circumferential wall, said cutting surrounding surface having a lower cutting surrounding edge and an upper cutting surrounding edge disposed higher than said lower cutting surrounding edge in the up-down direction, said cutting surrounding surface intersecting with a vertical reference plane that is parallel to both the up-down direction and a front-rear direction to define a front cutting edge and a rear cutting edge, said front cutting edge having a first lower point on said lower cutting surrounding edge, and a second lower point on said upper cutting surrounding edge, said rear cutting edge having a first upper point on said lower cutting surrounding edge and higher than said first lower point in the up-down direction, and a second upper point on said upper cutting surrounding edge and higher than said second lower point in the up-down direction; and
a concaved paper pressing curve surface extending upwardly from said upper cutting surrounding edge to define a paper moving recess.

2. The cutting tool as claimed in claim 1, wherein said outer circumferential wall intersects with the vertical reference plane to define a front side edge and a rear side edge, said front cutting edge being connected with and intersecting said front side edge to form a front cutting angle (α1), said rear cutting edge being connected with and intersecting said rear side edge to form a rear cutting angle (α2), said concaved paper pressing curve surface intersecting with the vertical reference plane to define a curve edge which is connected between said second lower point and said second upper point, a front tangential line of said curve edge at said second lower point intersecting said front cutting edge to form a front paper moving angle (θ1), a rear tangential line of said curve edge at said second upper point intersecting said rear cutting edge to form a rear paper moving angle (θ2), the following conditions being satisfied: said front cutting angle (α1) +135°≤said front paper moving angle (θ1)≤said front cutting angle (α1) +170°, and said rear cutting angle (α2) +135° said rear paper moving angle (θ2)≤said rear cutting angle (α2) +170°.

3. The cutting tool as claimed in claim 2, wherein said cutting surrounding surface includes a first surrounding surface section extending circumferentially to have two ends, and a second surrounding surface section extending rearwardly from said ends of said first surrounding surface section, said first surrounding surface section intersecting a horizontal reference plane that is normal to the axis to form a first cut-in angle (β1), said second surrounding surface section intersecting the horizontal reference plane to form a second cut-in angle (β2) that is larger than said first cut-in angle (β1).

4. A hole punch comprising:
an anvil seat having an anvil cavity;
a frame disposed on said anvil seat;
a handle module pivotably connected to said frame; and
at one cutting tool as claimed in claim 1, said cutting tool being disposed on and movable relative to said frame in the up-down direction and aligned with said anvil cavity such that rotation of said handle module is translated to a vertical movement of said cutting tool through said anvil cavity.

5. The hole punch as claimed in claim 4, wherein said cylindrical pin of said cutting tool further includes a top end surface connected with a top periphery of said outer circumferential wall, said top end surface being formed with a weight reducing hole which extends downwardly toward said concaved paper pressing curve surface and terminates at a hole bottom that is spaced apart from said concaved paper pressing curve surface, said hole punch further comprising at least one connecting pin which is connected between said handle module and said cylindrical pin to translate the rotation of said handle module into the vertical movement of said cutting tool.
